(19) United States
(12) Patent Application Publication
(10) Pub. No.: US 2022/0238023 A1
(43) Pub. Date: Jul. 28, 2022

(54) CUSTOMIZABLE AUTONOMOUS VEHICLE EXPERIENCE FOR LARGE SCALE EVENTS

(71) Applicant: GM Cruise Holdings LLC, San Francisco, CA (US)

(72) Inventors: Aakanksha Mirdha, San Francisco, CA (US); Alexander Willem Gerrese, San Francisco, CA (US); Jeremy Stephen Juel, San Francisco, CA (US); Yifei Zhang, San Francisco, CA (US)

(73) Assignee: GM Cruise Holdings LLC, San Francisco, CA (US)

(21) Appl. No.: 17/159,372

(22) Filed: Jan. 27, 2021

(51) Int. Cl. G08G 1/00; G06Q 10/02; G01C 21/34; G06Q 10/04; B60K 37/02

(52) U.S. Cl. CPC G08G 1/202; G06Q 10/02; G01C 21/3438; B60K 2370/164; B60K 37/02; G08G 1/205; G06Q 10/04

(57) ABSTRACT

Systems and methods for customizable autonomous vehicle service for large scale events. A centralized ride management system allows event hosts to integrate with a rideshare vehicle fleet for booking, customizing, tracking, and managing guest rides. The centralized ride management system collects basic event information from the host, such as event location, event start time, number of event guests, and guest pick-up locations. Using this information, the centralized ride management system schedules various guest pick-up times and determines routes to the event location that optimize traffic conditions and reduce congestion at the drop-off location.

### FIELD OF THE DISCLOSURE

The present disclosure relates generally to autonomous vehicles (AVs) and to systems and methods for event rides.

### BACKGROUND

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. The vehicles can also be used to pick up packages and/or other goods and deliver the packages and/or goods to selected destinations.

Vehicles are often used to provide rides to passengers who are attending a large event. For example, rideshare vehicles may be used to provide rides to sporting events, concerts, shows, and/or parties. Many vehicles arriving at a destination at the same time can cause congestion and heavy traffic. In some examples, an event host may offer to pay for rides for event guests, and provide a promotion code or subsequent reimbursement for the ride.

### SUMMARY

Systems and methods are provided for a customizable autonomous vehicle experience for large scale events. In particular, a centralized ride management system allows event hosts to integrate with a rideshare vehicle fleet for booking, customizing, tracking, and managing guest rides. The centralized ride management system collects basic event information from the host, such as event location, event start time, number of event guests, and guest pick-up locations. Using this information, the centralized ride management system schedules various guest pick-up times and determines routes to the event location that optimize traffic conditions and reduce congestion at the drop-off location.

The customizable autonomous vehicle experience is provided by allowing event hosts or organizers to select a customized ride experience for guests, including selection of in-car music, in-car branding displays, and special in-car amenities. This allows hosts to create a distinguished and memorable experience for their guests. Furthermore, hosts can pay for guest rides directly, eliminating the need for promotion codes or subsequent reimbursement.

According to one aspect, a method for providing centralized ride management for events includes receiving a host event request including an event location, determining a plurality of guest pick-up locations based, at least in part, on the host event request, determining a plurality of guest pick-up times, and routing a plurality of vehicles to the plurality of guest pick-up locations.

According to another aspect, a system for autonomous vehicle ride management for an event, includes an online portal configured to receive a host event request including an event location, an event start time, and a plurality of guests; and a central computing system configured to receive the host event request, and route a plurality of vehicles to pick up each of the plurality of guests and drive the guests to the event location

According to another aspect, a method of providing a host interface for tracking attendance at an event, includes providing rides in a set of vehicles to a plurality of guests for driving each of the plurality of guests to the event; tracking a location of each of the set of vehicles; determining a guest status for each of a plurality of guests, based, at least in part, on information from each of the set of vehicles; and displaying, via the host interface, aggregate guest statuses.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

To provide a more complete understanding of the present disclosure and features and advantages thereof, reference is made to the following description, taken in conjunction with the accompanying figures, wherein like reference numerals represent like parts, in which:

FIG. 1 is a diagram illustrating an autonomous vehicle, according to some embodiments of the disclosure;

FIG. 2 is a diagram illustrating a method for providing centralized ride management for events, according to some embodiments of the disclosure;

FIG. 3 is a diagram illustrating a portal for generating an event ride request, according to some embodiments of the disclosure;

FIG. 4 is a diagram illustrating a fleet of autonomous vehicles in communication with a central computer, according to some embodiments of the disclosure;

FIGS. 5A-5B show examples of an interface for host tracking of autonomous vehicle rides, according to some embodiments of the disclosure; and

FIG. 6 shows an example embodiment of a system for implementing certain aspects of the present technology.

### DETAILED DESCRIPTION

### Overview

Systems and methods are provided for a customizable autonomous vehicle experience for large scale events. A centralized ride management system allows event hosts to integrate with an autonomous vehicle fleet for booking, customizing, tracking, and managing guests' rides. The centralized ride management system collects basic event information from the host, such as event drop-off location, event start time (and doors-open time), number of guests, and pick-up locations. Using this information, the centralized ride management system schedules various guest pick-up times and routes that optimize traffic conditions and reduce congestion at the drop-off location. Additionally, the host can select a customized ride experience for guests, including selection of in-car music, in-car branding displays, and special in-car amenities. This allows hosts to create a distinguished and memorable experience for their guests. Furthermore, hosts can pay for guest rides directly, eliminating the need for promo codes or subsequent reimbursement.

Another issue that hosts currently face is tracking guest arrivals and/or aggregate guest arrival information. For example, hosts have no way of tracking guests' estimated time of arrival (ETA), whether guests are en route, or whether guests are stuck in traffic or otherwise delayed. Additionally, hosts have no easy way of determining whether a particular guest has arrived at the event venue. According to various implementations, a ride management portal is provided to hosts that allows hosts to track guests rides, as well as aggregate guest ride status. Using the ride management portal, a host can determine how many guests have already arrived at the event, and when additional guests are expected to arrive. This allows hosts to make real-time decisions such as whether an event (or a portion of an event) should start, whether an event should be temporarily be delayed until more guests arrive, or whether an event should be cancelled.

Generally, most guests arrive at an event venue within a small window of time, which can create congestion and/or traffic build up around the event site. For example, for a football game or a large concert, there can be a lot of traffic close to the start time, or even for an hour or more beforehand, due to the guests all driving to the same location at the same time. Traffic can also build up around venues for smaller concerts, shows, or events such as holiday parties. Systems and methods are provided for an event host or organizer to arrange a rideshare service, through which vehicle arrival times can be staggered to minimize traffic. Additionally, vehicles can be routed to minimize traffic.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

Example Autonomous Vehicle Configured for Event Host Ride Management

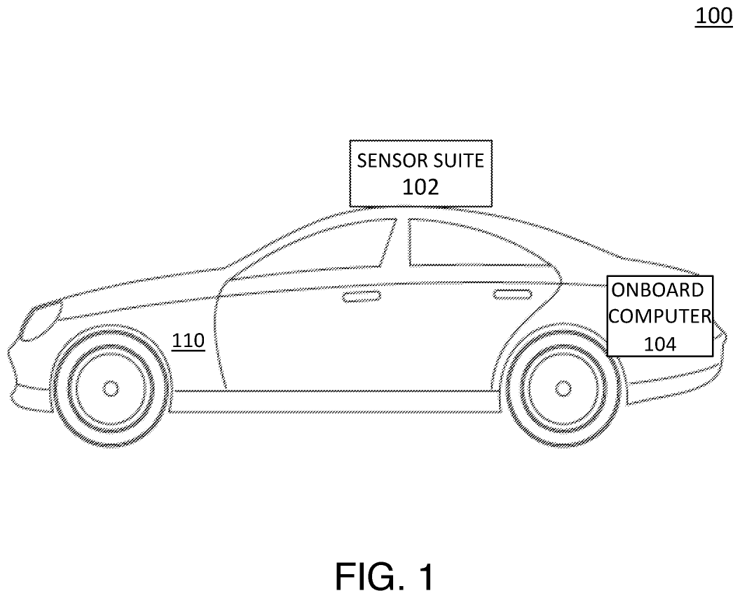

FIG. 1 is a diagram 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. The autonomous vehicle 110 is configured for ride management by an event host.

The sensor suite 102 includes localization and driving sensors. For example, the sensor suite may include one or more of photodetectors, cameras, RADAR, SONAR, LIDAR, GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment and, in some examples, sensor suite 102 data is used to detect selected events. In particular, data from the sensor suite can be used to update a map with information used to develop layers with waypoints identifying selected events, the locations of the encountered events, and the frequency with which the events are encountered at the identified location. In this way, sensor suite 102 data from many autonomous vehicles can continually provide feedback to the mapping system and the high fidelity map can be updated as more and more information is gathered.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. In some examples, the interior sensors can be used to detect passengers inside the vehicle. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface) and/or other interested parties (e.g., via an event host interface, via a vehicle coordinator, or via a remote expert interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

Example Method for Centralized Ride Management for Events

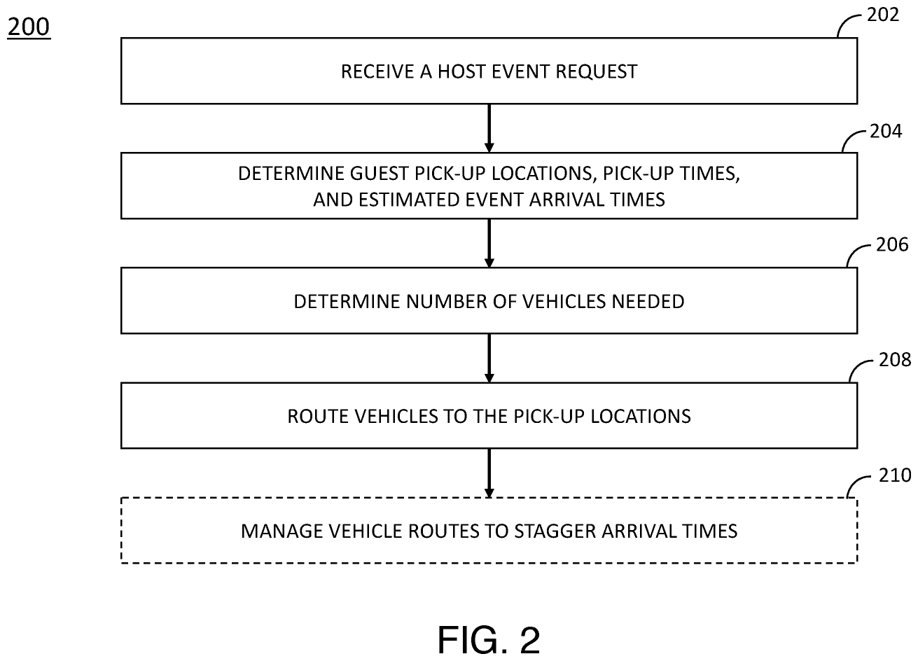

FIG. 2 is a diagram illustrating a method 200 for providing centralized ride management for events, according to some embodiments of the disclosure. At step 202, a host event request is received. The host event request includes an event location and an event start time. In some examples, the host event request includes an event start time as well as an event doors-open time, and in some examples, the host event request includes guest arrival time window. The event location includes one or more drop-off locations for the event. In some examples, the host event request includes guest information. The guest information can include one or more of guest names, guest phone numbers, guest photos, and guest pick-up locations. In some examples, guest information includes an approximate number of guests, and specific guest information is provided subsequently. This allows hosts to book or reserve event rides early and submit specific guest information after guest RSVP's are received.

At step 204, the centralized ride management system determines the guest pick-up locations, guest pick-up times, and guest event arrival times. The host provides guest information to the centralized ride management system, including one or more of guest names, guest phone numbers, guest photos, guest pick-up locations, and guest pick-up times. In some instances, guest information includes job title, job group or team, and preferred carpool co-guests. Other guest information can include favorite sports team, such that guests attending a sporting event can be matched in a carpool with others who are fans of the same team. In some examples, the host provides limited guest information and guests provide any further information requested by the ride management system. For instance, the host provides guest name and phone number, and the guest uses this information to access the ride management system. The guest then selects a pick-up time and pick-up location. In some examples, the guest enters a specific pick-up location and/or pick-up time. In other examples, the guest selects among multiple pick-up location options and/or times provided by the ride management system, as specified by the host. In some examples, the host provides guest pick-up locations and times, and the guests meet the vehicle at the pick-up location at the selected time. The vehicle confirms guest identity, for example, using a confirmation sent to the guest phone, or using a recognition technology such as facial recognition to match the guest to a photo provided by the host.

At step 206, a centralized ride management system determines the number of vehicles needed to fulfill the request. In some examples, the centralized ride management system determines the number of vehicles needed to fulfill the request at an initial booking stage, and determines specific pick-up information at a later date, closer to the event date. According to various examples, the centralized ride management system reserves a select number of vehicles for the event based on the number of guests, the event location, and the event start time.

At step 208, a plurality of vehicles are routed to the various pick-up locations. The vehicles are scheduled to arrive at the pick-up locations at the selected pick-up times. In some examples, a guest is alerted when the guest's vehicle arrives at the selected pick-up location. In some examples, guests can track their vehicles in a rideshare application.

After a vehicle of the plurality of vehicles has picked up its guest(s), the respective vehicle is further routed to the event drop-off location. In some implementations, at step 210, vehicle routes are managed to stagger vehicle arrival times. In particular, the centralized ride management system communicates with a routing coordinator to stagger arrival times of each of the plurality of vehicles at the event drop-off location.

In some implementations, event hosts additionally request guest pick-ups at the event location for departure after the event. According to various examples, guests can select a drop-off location. In other examples, guests can enter a specific drop-off location. Event hosts can specify a time window during which rides from the event are offered.

Example Host Event Ride Request Portal

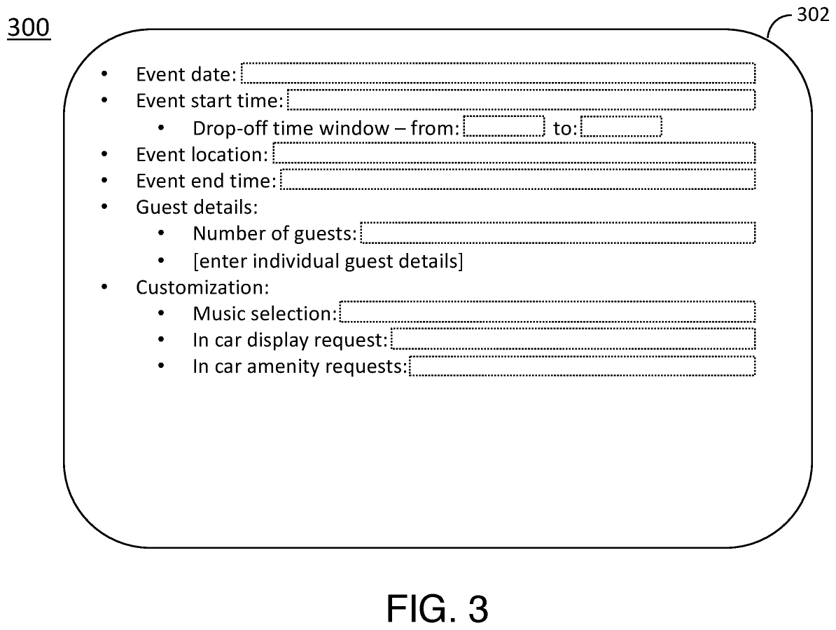

FIG. 3 is a diagram 300 illustrating a portal 302 for generating an event ride request, according to some embodiments of the disclosure. An event host can access the portal 302 and submit a request to a rideshare system for rides to an event. In various examples, an initial request includes an event date, event start time, event location, and an approximate number of guests. In other examples, the initial request further includes a doors-open time window (from a beginning time to an end time), an event end time, and customization options. In some examples, once an initial request is approved by the rideshare system, the event host is prompted to provide further information. For example, guest information can be updated to include guest details.

According to some implementations, event details can be added and/or updated. For example, the doors-open window can be adjusted, the number of guests can be adjusted, and details about guest pick-up locations can be added. In some examples, a longer doors-open window can help decrease congestion and traffic around an event location. Vehicle customization details can be updated after specific event themes and branding are determined.

In some implementations, an event end time is added by the host, and the host also requests rides for guests departing the event. In some examples, the host can set the time rides begin being offered towards the end of an event. A longer event end window can help decrease congestion and traffic around the event location and ensure a sufficient number of vehicles are available for departing guests.

In some examples, certain selections are more expensive than others, and some options may be added for set fees.

Guest information is provided by the host and includes one or more of guest name, guest phone number, guest photo, guest pick-up address, and guest job title. In some examples, the host provides the guest pick-up address. In other examples, the guest is able to access a portal to select a pick-up location. In some implementations, a host offers rides through the rideshare service from select pick-up locations to the event venue. The select pick-up locations may be shuttle stops, bus stops, or other public areas where guests can wait for rides. In other examples the host offers rides through the rideshare service from a guest's selected address. The guest may enter any pick-up address, for instance a residential address or a business address, and the vehicle picks up the guest at the entered address. In some examples, for rides to an event, a guest can select from multiple drop off locations (e.g., a large venue may have multiple entrances), and in some examples, a guest can enter a drop-off address. In some examples, a guest may choose an alternate nearby drop off location to avoid congestion.

Similarly, in some examples, the host selects the pick-up time for guests for rides to the event, while in other examples, guests select (or enter) a desired pick-up time. In some implementations, the rideshare service determines the pick-up time based on a selected arrival time. The arrival time can be selected by the host, or the host can allow the guest to select the arrival time. In some implementations, guest arrival times are staggered to prevent traffic and congestion at the event venue, and, as arrival times are reserved, guests can choose among remaining available arrival times.

In some implementations, rides through the rideshare service are offered to guests departing the event. In some examples, the host offers rides from the event venue to select drop-off locations. The select drop-off locations may be shuttle stops, bus stops, or other public areas, similar to where guests were picked up. In other examples the host offers rides through the rideshare service to a guest's selected address. The guest may enter a drop-off address, for instance a residential (home) address or a business address, and the vehicle drops off the guest at the entered address. The host can specify and/or outline an area within which rides are sponsored, and destinations outside that area may not be accepted and/or approved. In some examples, guests can reserve departure rides for specific times before the event. In some examples, event departure times can be requested or updated by guests during the event, since desired departure times can change once an event has begun.

As shown in the portal 302, a host can also customize guest rides. Currently, hosts have no control over their guests' ride experience and a ride is entirely dependent on factors out of the host's control, such as driver behavior, branding, car music, car smell, and co-riders. If a host arranges a rideshare service with an autonomous vehicle fleet, the host can customize the ride experience. In particular, a host can specify music, visuals, and lighting. In some examples, a host can select a video that plays on a screen in the vehicle during the ride. The host can include branding in the ride through visual and audio media, and/or a host can play and display advertisements. In some examples, the customization is selected to match an event theme. A host can also select a specific smell for the vehicle. In some examples, the host can offer refreshments in the vehicle including beverages and/or food. A host can specify vehicle driving behaviors.

In some implementations, a host can specify that certain passengers are to be grouped together in vehicle. For example, for a sports event, passengers may only be grouped together if they are fans of the same team. In another example, for a corporate event, employees who work in similar departments, teams, or levels can be grouped together.

According to various implementations, hosts can also customize payment options. In some examples, hosts pay for guest rides. Ride invitations can be sent to guests and rides are fully sponsored by the host. Currently there are limited options for a host to sponsor a guest ride to or from an event, and options include providing a guest with a promo code and/or reimbursing a guest after the fact. Both of these options create some inconvenience for the user, and a reimbursement system is also inconvenient and time-consuming for the host. However, if an event host or organizer arranges a rideshare service as provided herein, the host can pay the rideshare service directly, and guests do not need to arrange for ride payment. In other examples, a host sponsors guest rides up to a specified amount after which the guest pays any remaining fee. In further examples, a host can pay a percentage of the ride cost for each guest. In these examples, the guest may have an account with the rideshare service, through which to pay a portion of the ride fare.

Example of Autonomous Vehicle Fleet

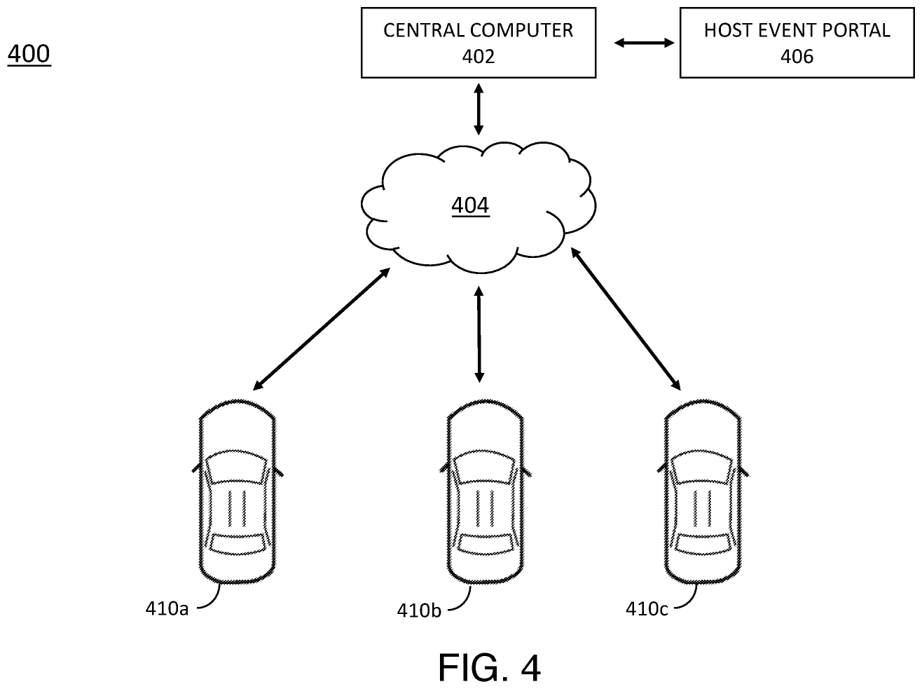

FIG. 4 is a diagram 400 illustrating a fleet of autonomous vehicles 410a, 410b, 410c in communication with a central computer 402, according to some embodiments of the disclosure. As shown in FIG. 4, the vehicles 410a-410c communicate wirelessly with a cloud 404 and a central computer 402. The central computer 402 includes a routing coordinator and a database of information from the vehicles 410a-410c in the fleet. Autonomous vehicle fleet routing refers to the routing of multiple vehicles in a fleet. The central computer also acts as a centralized ride management system for selected events, for example events booked through the portal 302 of FIG. 3. In some implementations, the autonomous vehicles 410a-410c communicate directly with each other.

When an event ride request is received from a host event portal 406, the host event portal 406 communicates the request with the central computer 402. The central computer 402 determines whether there are a sufficient number of vehicles available at the selected time and in the selected location to fulfill the request. In some examples, a rideshare service has already committed a portion of its vehicle fleet to other large scale events and does not have enough vehicle remaining on the selected vehicle to fulfill the request. Once the central computer 402 determines there are enough vehicles available to fulfill the request, the request is confirmed and the vehicles are reserved for the event. To confirm the request, the central computer collects information from the host as described above with respect to the portal 302 of FIG. 3.

Using the information provided through the portal 302 by the host (and, in some examples, information provided by guests), the routing coordinator selects various autonomous vehicles 410a-410c to fulfill ride requests for the event, and generates a route for each of the autonomous vehicles 410a-410c. In some examples, vehicles are selected and routes are generated close to and/or on the day of the event. In other examples, the routing coordinator provides each vehicle 410a-410c with a set of parameters and the vehicles 410a-410c each generate an individualized specific route. The generated route includes a route from each autonomous vehicle's 410a-410c present location to the pick-up location, and a route from the pick-up location to the final destination. Each of the autonomous vehicles 410a, 410b, 410c in the fleet are equipped to participate in providing rides for events as described with respect to FIGS. 2 and 3. The vehicles 410a, 410b, 410c communicate with a central computer 402 via a cloud 404.

In some implementations, the routing coordinator generates routes for each of the autonomous vehicles 410a-410c that optimize for reducing congestion at the drop-off location while not significantly increasing individual arrival times for any of the vehicles 410a-410c. In one example, the event is a football game, which typically causes a lot of traffic as most guests aim to arrive at the same time. In another example, the event is a music concert, which similarly causes a lot of traffic as most guests aim to arrive at the same time. If an organizer arranges rides with a rideshare service, the routing coordinator can stagger drop-off times such that guests arrive at sufficiently different times to alleviate the congestion.

In some implementations, event guests carpool to an event. In some examples, the routing coordinator groups guests together based on location and pick-up times. In other examples, a host groups selected guests together. Carpooling helps reduce traffic at the event location.

Similarly, if an event organizer arranges for guest pick-up following an event with a rideshare service, the routing coordinator can optimize routes to alleviate congestion at the event venue. In some examples, because the autonomous vehicles in a fleet are interchangeable, using an autonomous vehicle rideshare service helps reduce traffic following an event by allowing guests to enter any nearby autonomous vehicle from the fleet, as opposed to current rideshare services that require guests to find the allocated vehicle that has been assigned to them/their route. Once a guest enters an autonomous vehicle, the route information can be determined for the respective vehicle to drive the guest to their destination. Using an autonomous vehicle rideshare service for event pick-up can prevent vehicles from standing and/or waiting at an event for a specific guest to find them, which causes increased traffic. Additionally, since the routing coordinator has information on the routes for all the vehicles in the fleet, the routing coordinator can adjust vehicle routes to reduce congestion. In some examples, guests are grouped for carpooling according to efficient routing determinations.

According to various implementations, the host provides the central computer 402 with guest information, and when an autonomous vehicle 410a-410c picks up a guest, the autonomous vehicle 410a-410c verifies guest identity. In various examples, the autonomous vehicles 410a-410c verify guest identity both for rides to an event as well as for rides from an event. In some examples, the autonomous vehicles 410a-410c have guest photos provided by the host (or by the guest), and use facial recognition technology to verify guest identity. In some examples, identity is confirmed by sending a verification message to the identified guest's phone number. In other examples, the autonomous vehicles verify guest identity by requesting a confirmation code from a rideshare service app on a passenger's phone. Once a passenger identity is determined, the autonomous vehicle 410a-410c can determine a route to a predetermined destination. In other examples, once passenger identity is determined, the passenger can communicate destination requests to the autonomous vehicle 410a-410c via a rideshare application on the passenger's device.

In some examples, passengers group themselves to share rides with friends who live nearby and all enter the car together. In other examples, a host groups two or more guests together. Guests can be directed to find a specific vehicle, e.g., vehicle “A”, and a vehicle temporarily identifies itself with an “A” on the outside of the vehicle to distinguish from other vehicles. In some examples, guests can be grouped together in real-time as they are exiting a venue, and guests can be identified, for example, via their handheld devices. In various examples, the host cost for different grouping options varies.

In some implementations, a host may elect to have a selected number of autonomous vehicles waiting at the event location at any given point in time, and the number may change based on the time. For example, during the beginning or middle of an event, a host may choose to have just a few autonomous vehicles waiting for guests who choose to depart early (e.g., 5 vehicles), while towards the end of an event, a host may choose to have a much higher number of autonomous vehicles waiting for guests (e.g., 20 or more vehicles).

According to some implementations, autonomous vehicles 410a-410c in a fleet can be dynamically allocated to provide rides to and/or from an event. Once a vehicle 410a-410c is allocated to an event, the vehicle displays the customizations selected by the host. Once a passenger is dropped off, the vehicle 410a-410c can return to general fleet allocation by simply dynamically replacing the customizations with default settings or with customizations requested by the next passenger. In some instances, the customizations include amenities such as beverages and/or food, and in these instances, the beverages and/or food are removed from the vehicle before it is returned to general allocation in the fleet. In some examples, for events with beverages and/or food provided during rides to the event, one or more vehicle service personnel is present at or nearby the drop-off location to clean out the vehicles and return them to general allocation in the fleet.

In some implementations, autonomous vehicles are used to provide rides from certain pick-up spots to predetermined destination locations such as airports, schools, restaurants and/or bars. In this way, the autonomous vehicles can act as airport shuttles or school busses. In some examples, the rideshare app can display available rides to nearby events, such that the events are discoverable on the app. When a passenger finds an event on the app, the passenger can reserve a spot on the vehicle. Depending on how the host/organizer has set up the ride, the passenger follows instructions to proceed to a pick-up spot/shuttle stop, or wait at the current location for the vehicle.

As described above, each vehicle 410a-410c in the fleet of vehicles communicates with a routing coordinator. Thus, information gathered by various autonomous vehicles 410a-410c in the fleet can be saved and used to generate information for future routing determinations. For example, sensor data can be used to generate route determination parameters. In general, the information collected from the vehicles in the fleet can be used for route generation or to modify existing routes. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more travelling preferences and/or routing goals. In some examples, the routing coordinator uses collected position data corresponding to emergency events to generate a best route for an autonomous vehicle to avoid a potential emergency situation.

According to various implementations, a set of parameters can be established that determine which metrics are considered (and to what extent) in determining routes or route modifications. For example, expected congestion or traffic based on a known event can be considered. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, safety of the route plan, and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints.

Routing goals may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

Some examples of routing goals include goals involving trip duration (either per trip, or average trip duration across some set of vehicles and/or times), physics, laws, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridesharing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, passenger safety, pedestrian safety, toll cost, etc. In examples where vehicle demand is important, routing goals may include attempting to address or meet vehicle demand.

Routing goals may be combined in any manner to form composite routing goals; for example, a composite routing goal may attempt to optimize a performance metric that takes as input trip duration, rideshare revenue, and energy usage and also, optimize a comfort metric. The components or inputs of a composite routing goal may be weighted differently and based on one or more routing coordinator directives and/or passenger preferences.

Likewise, routing goals may be prioritized or weighted in any manner. For example, a set of routing goals may be prioritized in one environment, while another set may be prioritized in a second environment. As a second example, a set of routing goals may be prioritized until the set reaches threshold values, after which point a second set of routing goals take priority. Routing goals and routing goal priorities may be set by any suitable source (e.g., an autonomous vehicle routing platform, an autonomous vehicle passenger).

The routing coordinator uses maps to select an autonomous vehicle from the fleet to fulfill a ride request. In some implementations, the routing coordinator sends the selected autonomous vehicle the ride request details, including pick-up location and destination location, and an onboard computer on the selected autonomous vehicle generates a route and navigates to the destination. In some implementations, the routing coordinator in the central computing system 402 generates a route for each selected autonomous vehicle 410a-410c, and the routing coordinator determines a route for the autonomous vehicle 410a-410c to travel from the autonomous vehicle's current location to a first intermediate stop.

Example of a Ride Management Interface

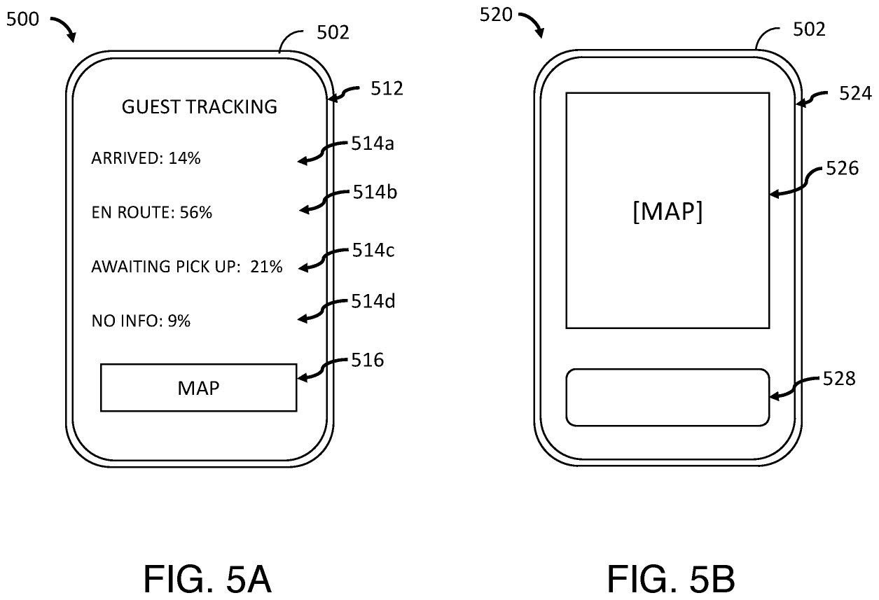

FIGS. 5A-5B show examples 500, 520 of an interface for host tracking of autonomous vehicle rides, according to some embodiments of the disclosure. FIG. 5A shows an example 500 of a device 502 showing a host guest tracking interface 512 for guest tracking. In particular, the host interface 512 indicates the percentage of guests that have arrived 514a, the percentage of guests that are en route to the event venue 514b, the percentage of guests that are awaiting pick up by an autonomous vehicle 514c, and the percentage of guests for whom there is currently no information 514d. Additionally, the host interface 512 includes a “map” button 516, which a host can select to view a map of event vehicles. In some implementations, the interface 512 shows numbers of guests instead of percentages. In some examples, the interface 512 includes a visual display of event statuses, such as a single bar that is divided into sections, where a first section represents a percentage of arrived guests, a second section represents a percentage of guests in vehicles en route to the venue, a third section represents a percentage of guests awaiting pick-up, and a fourth section represents a percentage of guests for whom the centralized ride management service has no info available. Each section has a dedicated color and occupies the portion of the bar corresponding to the percentage for the section.

In various examples, if a user selects the “map” button 516, the device 502 shows a map tracking interface 524, including a map 526. In some examples, the map 526 shows the locations of each of the guests based on the locations of the autonomous vehicles the guests are riding in. In some examples, guests who have arrived at the event location are not shown on the map, and in some examples, a percentage (or number) of guests arrived is shown at the event location. The host can zoom in and out on the map to more closely track various vehicles and/or guests. In some examples, the host can select any particular autonomous vehicle shown in the map 526, and the estimated time of arrival of the vehicle is displayed. In some examples, the button 528 allows a user to return to the guest tracking interface 512.

Example of a Computing System for Ride Requests

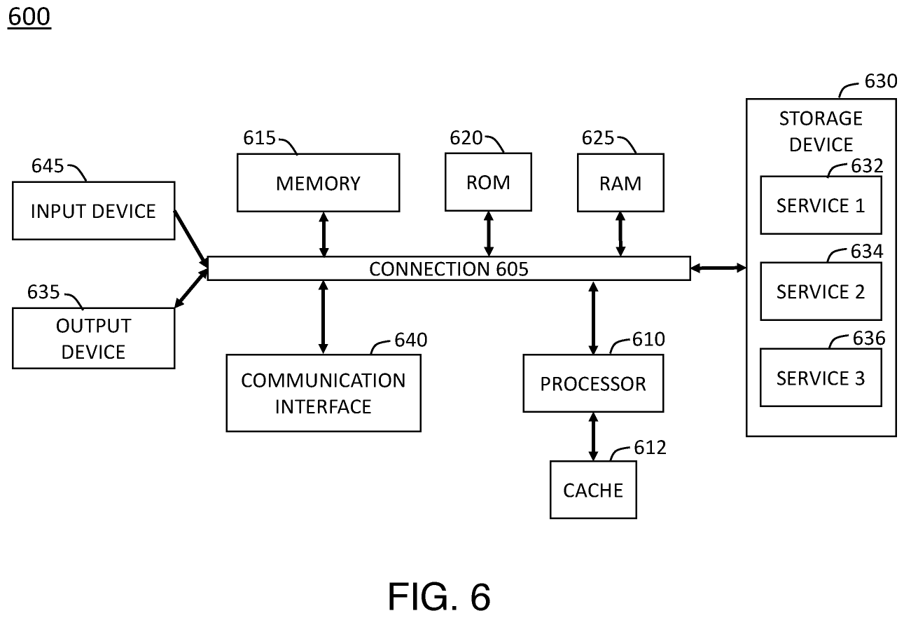

FIG. 6 shows an example embodiment of a computing system 600 for implementing certain aspects of the present technology. In various examples, the computing system 600 can be any computing device making up the onboard computer 104, the central computing system 402, or any other computing system described herein. The computing system 600 can include any component of a computing system described herein which the components of the system are in communication with each other using connection 605. The connection 605 can be a physical connection via a bus, or a direct connection into processor 610, such as in a chipset architecture. The connection 605 can also be a virtual connection, networked connection, or logical connection.

In some implementations, the computing system 600 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

The example system 600 includes at least one processing unit (CPU or processor) 610 and a connection 605 that couples various system components including system memory 615, such as read-only memory (ROM) 620 and random access memory (RAM) 625 to processor 610. The computing system 600 can include a cache of high-speed memory 612 connected directly with, in close proximity to, or integrated as part of the processor 610.

The processor 610 can include any general-purpose processor and a hardware service or software service, such as services 632, 634, and 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction, the computing system 600 includes an input device 645, which can represent any number of input mechanisms, such as a microphone for speech, a touch-sensitive screen for gesture or graphical input, keyboard, mouse, motion input, speech, etc. The computing system 600 can also include an output device 635, which can be one or more of a number of output mechanisms known to those of skill in the art. In some instances, multimodal systems can enable a user to provide multiple types of input/output to communicate with the computing system 600. The computing system 600 can include a communications interface 640, which can generally govern and manage the user input and system output. There is no restriction on operating on any particular hardware arrangement, and therefore the basic features here may easily be substituted for improved hardware or firmware arrangements as they are developed.

A storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as a processor 610, a connection 605, an output device 635, etc., to carry out the function.

As discussed above, each vehicle in a fleet of vehicles communicates with a routing coordinator. When a vehicle is flagged for service, the routing coordinator schedules the vehicle for service and routes the vehicle to the service center. When the vehicle is flagged for maintenance, a level of importance or immediacy of the service can be included. As such, service with a low level of immediacy will be scheduled at a convenient time for the vehicle and for the fleet of vehicles to minimize vehicle downtime and to minimize the number of vehicles removed from service at any given time. In some examples, the service is performed as part of a regularly-scheduled service. Service with a high level of immediacy may require removing vehicles from service despite an active need for the vehicles.

Routing goals may be specific or general in terms of both the vehicles they are applied to and over what timeframe they are applied. As an example of routing goal specificity in vehicles, a routing goal may apply only to a specific vehicle, or to all vehicles of a specific type, etc. Routing goal timeframe may affect both when the goal is applied (e.g., urgency of the goal, or, some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

In various implementations, the routing coordinator is a remote server or a distributed computing system connected to the autonomous vehicles via an internet connection. In some implementations, the routing coordinator is any suitable computing system. In some examples, the routing coordinator is a collection of autonomous vehicle computers working as a distributed system.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### SELECT EXAMPLES

Example 1 provides a method for providing centralized ride management for events, comprising receiving a host event request including an event location; determining a plurality of guest pick-up locations based, at least in part, on the host event request; determining a plurality of guest pick-up times; and routing a plurality of vehicles to the plurality of guest pick-up locations.

Example 2 provides a method according to one or more of the preceding and/or following examples, further comprising estimating a plurality of guest arrival times at the event location, wherein each of the plurality of guest arrival times are based, at least in part, on a respective one of the plurality of guest pick-up times.

Example 3 provides a method according to one or more of the preceding and/or following examples, further comprising managing routes of each of the plurality of vehicles between the guest pick-up locations and the event location to stagger ones of the plurality of guest arrival times.

Example 4 provides a method according to one or more of the preceding and/or following examples, wherein determining the plurality of guest pick-up locations further includes receiving ones of guest pick-up locations from respective guests.

Example 5 provides a method according to one or more of the preceding and/or following examples, further comprising tracking each of the plurality of vehicles.

Example 6 provides a method according to one or more of the preceding and/or following examples, further comprising displaying a respective vehicle location for each of the plurality of vehicles on a host interface.

Example 7 provides a method according to one or more of the preceding and/or following examples, further comprising providing a host interface configured to display aggregate guest statuses.

Example 8 provides a method according to one or more of the preceding and/or following examples, wherein the aggregate guest statuses include at least one of number of guests arrived, number of guests en route, and number of guests awaiting pick up.

Example 9 provides a method according to one or more of the preceding and/or following examples, further comprising receiving at least one customization setting for the plurality of vehicles.

Example 10 provides a method according to one or more of the preceding and/or following examples, wherein the customization setting includes at least one of a music selection, a video display selection, and a lighting selection.

Example 11 provides a system for autonomous vehicle ride management for an event, comprising an online portal configured to receive a host event request including an event location, an event start time, and a plurality of guests; and a central computing system configured to receive the host event request, and route a plurality of vehicles to pick up each of the plurality of guests and drive the guests to the event location

Example 12 provides a system according to one or more of the preceding and/or following examples, wherein the online portal is further configured to receive vehicle customization settings for the plurality of vehicles.

Example 13 provides a system according to one or more of the preceding and/or following examples, wherein further comprising a host interface configured to display aggregate guest statuses for the plurality of guests.

Example 14 provides a system according to one or more of the preceding and/or following examples, wherein the aggregate guest statuses include at least one of number of guests arrived, number of guests en route, and number of guests awaiting pick up.

Example 15 provides a system according to one or more of the preceding and/or following examples, wherein the central computing system is further configured to track each of the plurality of vehicles, and wherein the host interface is further configured to display a respective vehicle location for each of the plurality of vehicles.

Example 16 provides a system according to one or more of the preceding and/or following examples, wherein the central computing system is further configured to contact each of the plurality of guests and receive pick-up location selections for each of the plurality of guests.

Example 17 provides a system according to one or more of the preceding and/or following examples, wherein the host event request further includes a plurality of pick-up guest locations.

Example 18 provides a method of providing a host interface for tracking attendance at an event, comprising: providing rides in a set of vehicles to a plurality of guests for driving each of the plurality of guests to the event; tracking a location of each of the set of vehicles; determining a guest status for each of a plurality of guests, based, at least in part, on information from each of the set of vehicles; and displaying, via the host interface, aggregate guest statuses.

Example 19 provides a method according to one or more of the preceding and/or following examples, further comprising displaying a location of each of the plurality if guests based, at least in part on the location of each of the vehicles.

Example 20 provides a method according to one or more of the preceding and/or following examples, wherein the guest status includes one of a set of status options and further comprising determining the percentage of guests statuses in each status option to generate the aggregate guest statuses.

### Variations and Implementations

According to various examples, driving behavior includes any information relating to how an autonomous vehicle drives. For example, driving behavior includes how and when the autonomous vehicle actuates its brakes and its accelerator, and how it steers. In particular, the autonomous vehicle is given a set of instructions (e.g., a route or plan), and the driving behavior determines how the set of instructions is implemented to drive the car to and from various destinations, and, potentially, to stop for passengers or items. Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, “legal ambiguity” conduct (e.g., in a solid-green left turn situation, whether a vehicle pulls out into the intersection or waits at the intersection line), action profiles (e.g., how a vehicle turns, changes lanes, or performs a driving maneuver), and action frequency constraints (e.g., how often a vehicle changes lanes). Additionally, driving behavior includes information relating to whether the autonomous vehicle drives and/or parks.

As will be appreciated by one skilled in the art, aspects of the present disclosure, in particular aspects of a perception system for an autonomous vehicle, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A method for providing centralized ride management for events, comprising:
receiving a host event request including an event location;
determining a plurality of guest pick-up locations based, at least in part, on the host event request;
determining a plurality of guest pick-up times; and
routing a plurality of vehicles to the plurality of guest pick-up locations.

2. The method of claim 1, further comprising estimating a plurality of guest arrival times at the event location, wherein each of the plurality of guest arrival times is based, at least in part, on a respective one of the plurality of guest pick-up times.

3. The method of claim 2, further comprising managing routes of each of the plurality of vehicles between the guest pick-up locations and the event location to stagger ones of the plurality of guest arrival times.

4. The method of claim 1, wherein determining the plurality of guest pick-up locations further includes receiving guest pick-up locations from at least one of respective guests and an event host.

5. The method of claim 1, further comprising tracking each of the plurality of vehicles.

6. The method of claim 5, further comprising displaying a respective vehicle location for each of the plurality of vehicles in a host interface.

7. The method of claim 1, further comprising providing a host interface configured to display aggregate guest statuses.

8. The method of claim 7, wherein the aggregate guest statuses include at least one of number of guests arrived, number of guests en route, and number of guests awaiting pick up.

9. The method of claim 1, further comprising receiving at least one customization setting for the plurality of vehicles.

10. The method of claim 9, wherein the customization setting includes at least one of a music selection, a video display selection, and a lighting selection.

11. A system for autonomous vehicle ride management for an event, comprising:
a online portal configured to receive a host event request including an event location, an event start time, and a plurality of guests; and
a central computing system configured to receive the host event request, and route a plurality of vehicles to pick up each of the plurality of guests and drive the guests to the event location.

12. The system of claim 11, wherein the online portal is further configured to receive vehicle customization settings for the plurality of vehicles.

13. The system of claim 11, further comprising a host interface configured to display aggregate guest statuses for the plurality of guests.

14. The system of claim 13, wherein the aggregate guest statuses include at least one of number of guests arrived, number of guests en route, and number of guests awaiting pick up.

15. The system of claim 13, wherein the central computing system is further configured to track each of the plurality of vehicles, and wherein the host interface is further configured to display a respective vehicle location for each of the plurality of vehicles.

16. The system of claim 11, wherein the central computing system is further configured to contact each of the plurality of guests and receive pick-up location selections for each of the plurality of guests.

17. The system of claim 11, wherein the host event request further includes a plurality of pick-up guest locations.

18. A method of providing a host interface for tracking attendance at an event, comprising:
providing a set of vehicles to a plurality of guests for driving each of the plurality of guests to the event;
tracking a location of each of the set of vehicles;
determining a guest status for each of a plurality of guests, based, at least in part, on information from each of the set of vehicles; and
displaying, via the host interface, aggregate guest statuses.

19. The method of claim 18, further comprising displaying a location of each of the plurality if guests based, at least in part on the location of each of the vehicles.

20. The method of claim 18, wherein the guest status includes one of a set of status options and further comprising determining the percentage of guests statuses in each status option to generate the aggregate guest statuses.
